(19) United States
(12) Patent Application Publication
(10) Pub. No.: US 2010/0247382 A1
(43) Pub. Date: Sep. 30, 2010

(54) FLUORESCENT BIOCHIP DIAGNOSIS DEVICE

(75) Inventor: Byoung -Su Lee, Yeosu-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: SILICONFILE TECHNOLOGIES INC., Seoul (KR)

(21) Appl. No.: 12/743,998

(22) PCT Filed: Nov. 10, 2008
(86) PCT No.: PCT/KR08/06624

§ 371 Date: May 20, 2010

(30) Foreign Application Priority Data
Nov. 23, 2007 (KR) 10-2007-0119994

(51) Int. Cl. G01N 30/00

(52) U.S. Cl. 422/69

(57) ABSTRACT

Disclosed is a fluorescent biochip diagnosis device including: an image sensor having a plurality of photo-detectors; and a band-pass filter unit having a plurality of band-pass filters formed on a plurality of the photo-detectors, wherein a plurality of the band-pass filters are implemented by forming a nanostructure pattern in a metal layer. Since the fluorescent biochip diagnosis device has little optical loss due to a short interval between the biochip and the photo-detector, excellent sensitivity can be provided. Also, since signals can be simultaneously measured by combining light beams having a short wavelength used as an illumination depending on a type of a fluorescent protein material, cost of the diagnosis device and a diagnosis time can be reduced.

### BACKGROUND OF THE INVENTION

1. Field of the Invention

The present invention relates to a biochip diagnosis device, and more particularly, to a fluorescent biochip diagnosis device including a plurality of band-pass filters having a metal nanostructure pattern formed on an image sensor having a plurality of photo-detectors. The diagnosis device is separately connected to a lower portion of the biochip to measure a fluorescent signal emitted from the biochip.

2. Description of the Related Art

In a typical biochip, reference samples containing biological molecules such as deoxyribonucleic acid (DNA) or protein are regularly arranged on a substrate made of glass, silicon, metal or nylon. The biochip can be classified into a DNA chip or a protein chip depending on a classification of the arranged reference sample. The biochip basically uses a biochemical reaction generated between a target sample and a reference sample mounted on a substrate. For example, the biochemical reaction generated between the reference sample and the target sample may include complementary DNA base sequencing or antigen-antibody interaction.

Most of the biochip diagnoses are accomplished by measuring biochemical reaction through an optical process. Typically, a fluorescent material is used in the optical process.

In an example of the optical process using a fluorescent material, the fluorescent material is combined with the target sample which will be administered to the reference sample mounted on a biochip to allow the fluorescent material to remain after a particular biochemical reaction between the reference sample and the target sample. Then, the fluorescent material emits light when it is irradiated by an external optical source, and the emitted light is measured.

FIG. 1 illustrates a typical structure of a conventional biochip.

Referring to FIG. 1, in the conventional biochip 100, various types of reference samples 120 are arranged at a regular interval on a substrate made of glass 110 or the like. In a typical biochip, the reference samples are changed depending on a measurement requirement. Hundreds of reference samples are used in a protein chip, and hundreds of thousands or millions of reference samples are used in a DNA chip.

In the conventional biochip 110, when a target sample is administered to various types of reference samples 120, biochemical reaction between the reference sample 120 and the target sample occurs. In the fluorescent biochip, the target material contains a certain amount of fluorescent material in its chemical bonds or the like. The fluorescent material remains after biochemical reaction between the target sample and the reference sample 120. Therefore, the biochemical reaction can be measured by measuring the amount of remaining fluorescent material.

The amount of remaining fluorescent material can be measured by measuring the intensity of fluorescent light. The amount of the remaining fluorescent material may be changed depending on how successful the biochemical reaction is. Accordingly, the amount of fluorescent light generated from the fluorescent material can be changed depending on the amount of the remaining fluorescent material. In a typical method of measuring the intensity of fluorescent light, the intensity of fluorescent signal having a short wavelength is measured by irradiating the samples with an illumination having a short wavelength.

Also, in a typical fluorescent biochip, a plurality of fluorescent protein (FP) materials are simultaneously applied in order to obtain various information with a single try of the diagnosis. The fluorescent protein materials may include a Blue FP(BFP), a Cyan FP(CFP), a Green FP(GFP), a Yellow FP(YFP), or the like.

FIG. 2 illustrates absorptivities of various fluorescent protein materials and their fluorescent spectrum.

Referring to FIG. 2, if the CFP is used as a fluorescent material, the illumination having a wavelength of 390 nm would be most efficient. In this case, the fluorescent light has a center wavelength of 450 nm, at which the fluorescent light has the highest intensity. Therefore, it would be efficient to use a filter having a center wavelength of 450 nm in order to detect the fluorescent light.

FIG. 3 illustrates a scanner for measuring fluorescent signals generated from a conventional biochip.

When a plurality of fluorescent protein materials are used, various types of laser beams are used as an illumination. Images corresponding to each fluorescent protein material can be obtained by adopting an emission filter corresponding to each fluorescent protein (FP) material.

Typically, the intensity of fluorescent light generated from the fluorescent material by the illumination is very small in comparison with the intensity of the illumination. Since the intensity of fluorescent light is measured individually for each sample using a high density of collimated laser beams as the illumination in order to increase the intensity of fluorescent light, the measurement time increases in proportion to number of samples. Therefore, the measurement time correspondingly increases when the number of samples increases from several hundreds to tens or hundreds of thousands.

In addition, separate optical or electrical devices such as a high-precision microscope, a CCD camera, a photo multiplier (PM) tube, and a band-pass filter should be used to detect the light generated from the fluorescent material. Such expensive devices make difficult to commercialize biochips.

Typically, a charge-coupled device (CCD) or complementary metal-oxide semiconductor (CMOS) photodiode is used as a photo-detector. Since the CMOS photodiode has a low sensitivity, the CCD camera is usually adopted. However, since the CCD camera made of a semiconductor material is vulnerable to thermal noise, a long exposure time is necessary to collect light when the intensity of light generated from a fluorescent or luminescent material is weak. Since thermal noise also increases in proportion to the exposure time, detected light may contain much noise, and this will degrade optical detection efficiency.

For this reason, an expensive microscope is mounted to increase optical detection efficiency in the CCD camera, or a system for cooling the CCD camera is adopted to reduce thermal noise generated from thermal electrons. These methods also have shortcomings such as complicated cooling processes or additional devices.

For example, if the measurement device shown in FIG. 3 measures fluorescent signals using a plurality of fluorescent protein materials, each sample should be individually measured using a plurality of laser sources and the same number of filters as that of the laser sources. Therefore, this method also increases cost of the diagnosis device and has a long diagnosis time.

Since commonly used biochips use tens of thousands to millions of types of reference samples, it is physically impossible to obtain commonality and reliability of each reference sample. Therefore, all reaction results for each sample are not reliable, and so, a statistical processing method is typically used to prevent this. That is, a method of examining reliability for reaction results by distributing and arranging the same sample is used, and they are processed using a statistical method and a computer program.

Consequently, in order to perform a typical biochip diagnosis, a computer and a program are additionally required to process the results obtained from the diagnosis chips. Also, since they are analyzed using a separate computer program, it would take a lot of time to obtain the diagnosis results.

### SUMMARY OF THE INVENTION

The present invention provides a fluorescent biochip diagnosis device which includes a band-pass filter having a metal nanostructure pattern to provide a high sensitivity and extract diagnosis results for a short time without collimated laser beams and expensive devices such as a scanner.

According to an aspect of the present invention, there is provided a fluorescent biochip diagnosis device comprising: an image sensor having a plurality of photo-detectors; and a band-pass filter unit having a plurality of band-pass filters formed on a plurality of the photo-detectors, wherein a plurality of the band-pass filters are implemented by forming a nanostructure pattern in a metal layer.

According to another aspect of the present invention, there is provided a fluorescent biochip diagnosis device comprising: a substrate having a photo-diode region which detects fluorescent light from a biochip, a vertical charge transfer region which is a charge transfer path where electric charges generated by an electroluminescence effect in the photodiode region are collected, and an isolation film; a gate insulation film and a gate electrode formed on the substrate in this order; an interlayer insulation film formed on the substrate having the gate electrode; and at least one metal layer formed to provide a circuit wiring within the interlayer insulation film, wherein at least one band-pass filter having a metal nanostructure is located on an extension line of at least the metal layer.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a typical structure of a conventional biochip;

FIG. 2 illustrates absorptivities of various fluorescent protein materials and their fluorescent spectrum;

FIG. 3 illustrates a scanner for measuring fluorescent signals generated from a conventional biochip;

FIG. 4 illustrates a metal nanostructure pattern of a band-pass filter;

FIG. 5 is a cross-sectional view illustrating a biochip and an underlying fluorescent biochip diagnosis device connected to the biochip according to the present invention; and

FIG. 6 illustrates a fluorescent biochip diagnosis device according to another embodiment of the present invention.

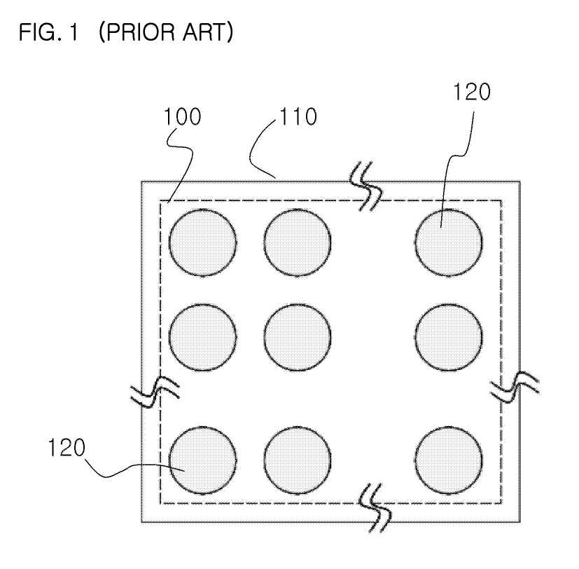

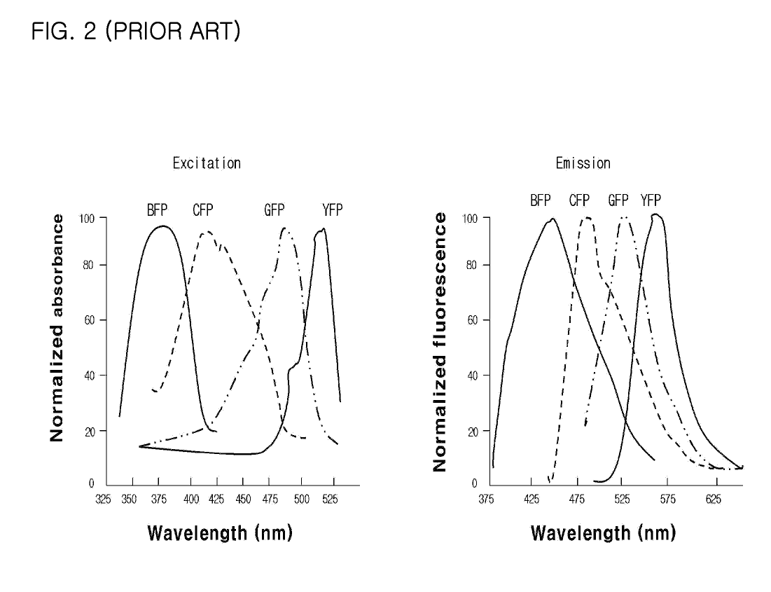

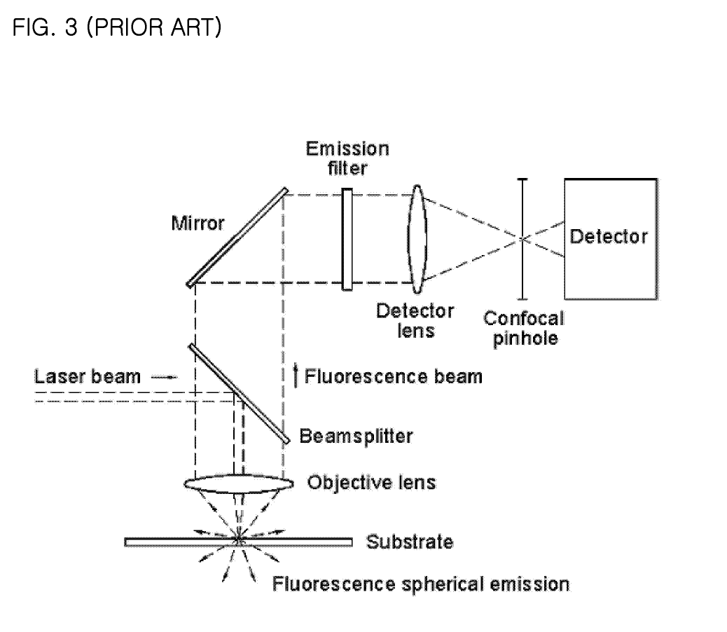

### DETAILED DESCRIPTION OF PREFERRED EMBODIMENTS

Hereinafter, exemplary embodiments of the present invention will be described in detail with reference to the accompanying drawings.

When light is incident to a metal thin film, electrons inside the metal vibrate while travel along an electric field perpendicular to a light-incident direction (i.e., surface plasmon). Since the incident light is attenuated due to such traveling electrons, it cannot be penetrated over a predetermined depth Lp. That is, the light is exponentially attenuated according to a penetration depth Lp inside the metal. Therefore, visible light cannot transmit a metal thin film having a thickness of about 100 nm or higher.

There have been important studies on penetration properties of a metal thin film having a nanostructure pattern smaller than a wavelength of incident light in the field of optics, bionics, or photonics. It has been known that, if a metal thin film having a thickness of hundreds nanometers has a pattern smaller than a wavelength of light, light can be abnormally transmitted.

That is, a metal layer (e.g., Ag) having a nanostructure pattern can serve as an optical filter. Such a structure is advantageous in that only a certain band of light can be transmitted or absorbed by controlling a metal nanostructure pattern.

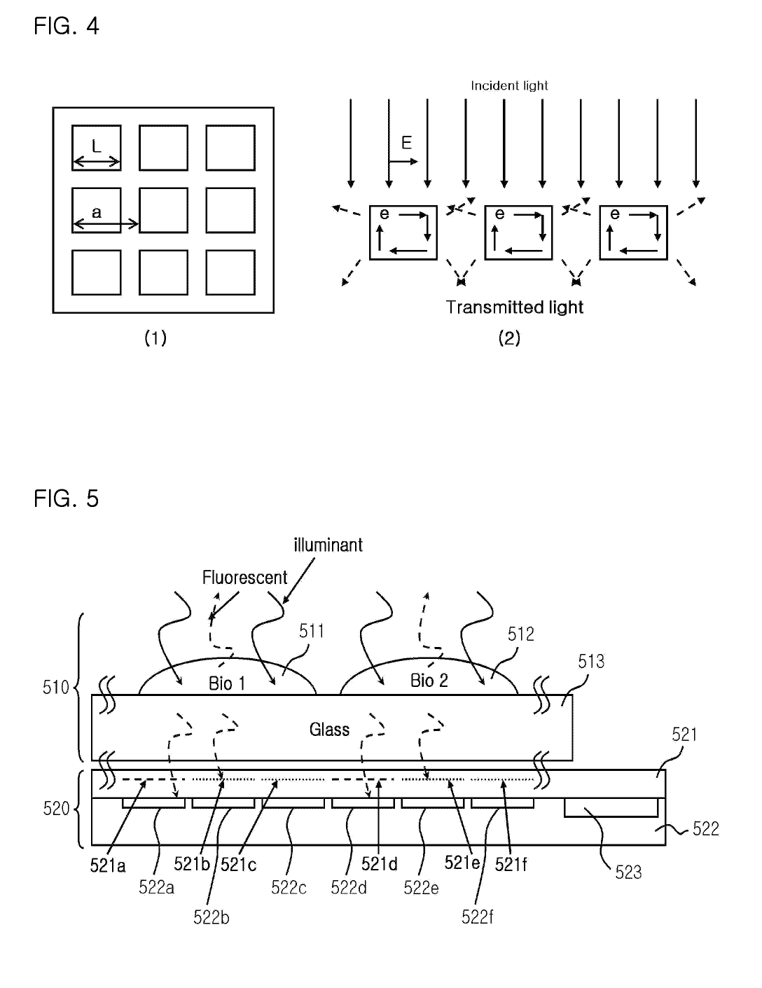

FIG. 4 illustrates a metal nanostructure pattern of a band-pass filter.

The thickness of the metal layer is determined by a bandwidth of a wavelength of light to be transmitted. Preferably, the thickness of the metal layer is set to 100 to 5,000 nm. If the bandwidth of the wavelength of light to be transmitted is large, the metal layer advantageously has a smaller thickness. If the bandwidth of the wavelength of light is small, the metal layer advantageously has a larger thickness.

The metal layer is preferably made of high-conductive transition metal such as Al, Ag, Au, Pt, or Cu. A distance a between repetitive patterns in the metal layer is determined by a wavelength of light to be transmitted, and should be smaller than the wavelength of light to be transmitted. In addition, since a length L of an opened interval determines transmittance, the opened interval preferably has an allowable maximum length.

For example, if a width of a metal wire is limited to 90 nm, the length L may be determined by L=a−90 nm.

Now, how light passes through a metal layer having a metal nanostructure pattern according to the present invention will be described with reference to FIG. 4.

When the light is incident to the metal layer having a nanostructure pattern, electrons (e) on a metal surface are affected by an electric field of the incident wave, and travel along a contour of the metal nanostructure. Therefore, strong radiation occurs in corners of the metal nanostructure. When the incident light match the metal nanostructure, transmitted light is generated by strong resonance. Consequently, the more corners the traveling electrons meet inside the metal layer, the stronger transmission may occur.

A center wavelength λc of the light transmitted through the metal layer can be determined by:

$${λ}_{c} = a \sqrt{\frac{{ɛ}_{m} {ɛ}_{d}}{{ɛ}_{m} + {ɛ}_{d}}} ,$$

where, εm denotes a real part of permittivity of metal, and εd denotes a real part of permittivity of a medium. The filter using the aforementioned metal layer is advantageous in that a desired wavelength and bandwidth can be obtained by changing a structure of a metal layer. Therefore, a band-pass filter can be selected without overlapping the fluorescent light to be detected and the illumination used for excitation corresponding to each fluorescent protein material.

FIG. 5 is a cross-sectional view illustrating a biochip and a fluorescent biochip diagnosis device separately connected to a lower portion of the biochip according to the present invention.

Different kinds of biological materials 511 and 512 are disposed on the biochip 510. Reaction results are measured by placing a biochip 510 on a fluorescent biochip diagnosis device 520 according to the present invention.

When the surface of the biochip 510 is irradiated from above by light beams having a uniform short wavelength selected by an illumination or a combination of light beams having a different short wavelength, a different wavelength band of fluorescent light is generated depending on what kind of and how much fluorescent material remains in each biological material 511 and 512.

The generated fluorescent light is radiated to upper and lower portions of the substrate 513 with the same brightness. The fluorescent biochip diagnosis device 520 according to the present invention makes contact with a backplane of the biochip 510 to measure the brightness of light radiated to the rear side. The light radiated to the rear side passes through a band-pass filter 521 disposed on the image sensor 522. That is, the light passes through a plurality of band-pass filters 521a to 521f disposed on a plurality of photo-detectors 522a or 522f. A plurality of the band-pass filters 521a to 521f are manufactured by forming a nanostructure pattern on the metal layer. As a result, only a proper wavelength band of light beams can pass through the band-pass filter and arrive at the photo-detector. The intensity of fluorescent light measured by a plurality of photo-detectors 522a to 522f is processed in a signal processing unit 523, and the diagnosis results are directly output.

A signal processing unit 523 is a means for processing electric signals converted from the light detected by a plurality of photo-detectors, and internally stores a program capable of analyzing measurement results in an image signal lo processor (ISP). Therefore, desired diagnosis results can be obtained within a short time without additional analyzing efforts.

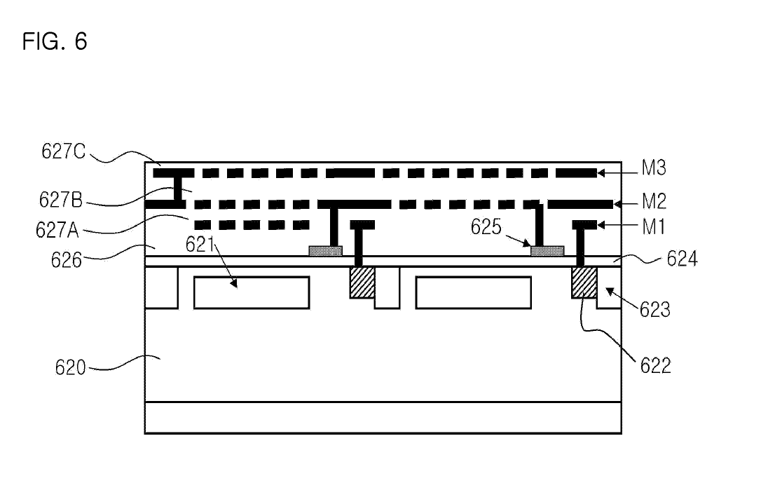

FIG. 6 illustrates a fluorescent biochip diagnosis device according to another embodiment of the present invention.

Referring to FIG. 6, the fluorescent biochip diagnosis device according to another embodiment of the present invention includes: a substrate 620 having a photodiode region 621 which detects fluorescent light from a biochip; a vertical charge transfer region 622 which is a charge transfer path where electric charges generated by an photoelectric effect in the photodiode region 621 are collected; and an isolation (e.g., STI: Shallow Trench Isolation) film 623; a gate insulation film 624 formed on the substrate 620; a gate electrode 625 formed on the gate insulation film 624; an interlayer insulation film 626 formed on the substrate having the gate electrode 625; at least one metal layer M1 to M3 having an insulation film interposed there for a circuit wiring within the interlayer insulation film 626; and at least one band-pass filter 627A to 627C having a metal nanostructure pattern located on an extension line of at least the metal layer M1 to M3.

The light incident to the fluorescent biochip diagnosis device passes through at least one band-pass filter 627A to 627C having a metal nanostructure pattern so that light having only a selected wavelength band is incident to the photodiode region 621. The band-pass filter can be applied to a single metal layer M3. When it is applied to a plurality of metal layers M1 to M3, color purity can be improved.

Since the thickness, material, and distance between patterns of the metal layers M1 to M3 having at least one band-pass filter 627A to 627C have been already described above, their detailed description will be omitted.

According to the present invention, since the fluorescent biochip diagnosis device has little optical loss due to a short interval between the biochip and the photo-detector, an excellent sensitivity can be provided. Also, since signals can be simultaneously measured by combining light beams having a short wavelength used as an illumination depending on a type of a fluorescent protein material, cost of the diagnosis device can be reduced. In addition, since signals are measured in a single try regardless of the number of reference samples, a diagnosis time can be reduced.

According to the present invention, the fluorescent biochip diagnosis device includes a signal processing unit internally having a program (for a reliability check and a statistical processing) capable of analyzing measurement results inside a diagnosis chip. Therefore, a desired diagnosis result can be obtained within a short time without a separate analysis process requiring a computer and a special program.

While the present invention has been particularly shown and described with reference to exemplary embodiments thereof, it will be understood by those skilled in the art that various changes in form and details may be made therein without departing from the spirit and scope of the present invention as defined by the appended claims.

1. A fluorescent biochip diagnosis device comprising:
an image sensor having a plurality of photo-detectors; and
a band-pass filter unit having a plurality of band-pass filters formed on the plurality of the photo-detectors,
wherein the plurality of the band-pass filters are implemented by forming a nanostructure pattern in a metal layer.

2. The fluorescent biochip diagnosis device according to claim 1, further comprising a signal processing unit which processes signals obtained from the plurality of the photo-detectors.

3. The fluorescent biochip diagnosis device according to claim 1, wherein the metal layer has a thickness determined by a bandwidth of a wavelength of transmitted light.

4. The fluorescent biochip diagnosis device according to claim 1, wherein the metal layer has a thickness of 100 to 1,500 nm.

5. The fluorescent biochip diagnosis device according to claim 1, wherein the distance between patterns of the metal layer is determined by a center wavelength of the transmitted light.

6. The fluorescent biochip diagnosis device according to claim 1, wherein the metal layer is formed of transition metal.

7. The fluorescent biochip diagnosis device according to claim 1, wherein the metal layer is formed of at least one material selected from a group consisting of Al, Ag, Au, Pt, or Cu.

8. The fluorescent biochip diagnosis device according to claim 1, wherein the band-pass filter unit is separately connected to a lower portion of the biochip while the band-pass filter unit is separated from the biochip.

9. A fluorescent biochip diagnosis device comprising:
a substrate having a photo-diode region which detects fluorescent light from a biochip, a vertical charge transfer region which is a charge transfer path where electric charges generated by an photoelectric effect in the photodiode region are collected, and an isolation film;
a gate insulation film and a gate electrode formed on the substrate in this order;
an interlayer insulation film formed on the substrate having the gate electrode; and
at least one metal layer formed to provide a circuit wiring within the interlayer insulation film,
wherein at least one band-pass filter having a metal nanostructure is located on an extension line of at least the metal layer.

10. The fluorescent biochip diagnosis device according to claim 9, wherein the metal layer has a thickness determined by a bandwidth of a wavelength of transmitted light.

11. The fluorescent biochip diagnosis device according to claim 9, wherein the metal layer has a thickness of 100 to 1,500 nm.

12. The fluorescent biochip diagnosis device according to claim 9, wherein a distance between patterns of the metal layer is determined by a center wavelength of transmitted light.

13. The fluorescent biochip diagnosis device according to claim 9, wherein the metal layer is formed of transition metal.

14. The fluorescent biochip diagnosis device according to claim 9, wherein the metal layer is formed of at least a material selected from a group consisting of Al, Ag, Au, Pt, or Cu.

15. The fluorescent biochip diagnosis device according to claim 2, wherein the metal layer has a thickness determined by a bandwidth of a wavelength of transmitted light.

16. The fluorescent biochip diagnosis device according to claim 2, wherein the metal layer has a thickness of 100 to 1,500 nm.

17. The fluorescent biochip diagnosis device according to claim 2, wherein the distance between patterns of the metal layer is determined by a center wavelength of the transmitted light.

18. The fluorescent biochip diagnosis device according to claim 2, wherein the metal layer is formed of transition metal.

19. The fluorescent biochip diagnosis device according to claim 2, wherein the metal layer is formed of at least one material selected from a group consisting of Al, Ag, Au, Pt, or Cu.

20. The fluorescent biochip diagnosis device according to claim 2, wherein the band-pass filter unit is separately connected to a lower portion of the biochip while the band-pass filter unit is separated from the biochip.
